(19) United States
(12) Patent Application Publication
(10) Pub. No.: US 2006/0245627 A1
(43) Pub. Date: Nov. 2, 2006

(54) Noninvasive dynamic analysis system and method of use thereof

(76) Inventor: Kouki Nagamune, Hyogo (JP)

Correspondence Address: CHRISTIE, PARKER & HALE, LLP, PO BOX 7068, PASADENA, CA, 91109-7068, US

(21) Appl. No.: 10/545,498

(22) PCT Filed: Feb. 8, 2005
(86) PCT No.: PCT/JP05/02183

§ 371 Date: Aug. 12, 2005

(51) Int. Cl. G06K 9/00

(52) U.S. Cl. 382/128

(57) ABSTRACT

A noninvasive dynamic analysis system is provided, in which a measured and analyzed result in a manual test may be fed back to an examiner, in real-time, to allow quantitative and dynamic evaluation of the result. The noninvasive dynamic analysis system includes a transmitter for transmitting an electromagnetic wave or an electromagnetic signal, two receivers fixed to the thigh and the cruris of the human body and capable of receiving the electromagnetic wave transmitted by the transmitter, an electromagnetic measuring device for determining the positions and the orientations of the two receivers based on information from the receivers, and a processing device, such as a personal computer, for calculating and indicating 6 DOF of the knee joint, based on the positions and the orientations of the two receivers, from the electromagnetic measuring device. The two receivers may be fixed to the thigh and the cruris by using two braces.

### FIELD OF THE INVENTION

The present invention relates to an analysis system for noninvasively calculating the six degrees-of-freedom of the knee, or the like, of the human body, in real-time, and during a manual test.

### DESCRIPTION OF THE RELATED ART

In a clinical assessment of an injury of the knee joint, it is very important to determine the existence of the injury in the joint support organization including the ligament and the joint capsule. In particular, if an injury of the cruciate ligament is overlooked in the assessment, the treatment of the injury may be very difficult due to an induced secondary alteration of the ligament.

For the clinical assessment of the ligament, various kinds of tests, represented by a varus/valgus stress test, the Lachman test and the Pivot Shift test, have been proposed.

In prior art, as a quantitative evaluation for the above manual test, the measurement is carried out using, for example, the Anterior Drawer test capable of being evaluated by a KT-1000 (TM), an X-ray or fluoroscopy.

In the KT-1000 described above, only an anterior translation can be measured. Therefore, another translation, such as a thrust translation, and a rotational degree, such as a flexion degree, cannot be measured. Further, the KT-1000 is not suitable for the manual test such as the Lachman test and the Pivot Shift test, because, in the KT-1000, a relatively large mechanical orthosis is attached to the cruris.

In one method of using an X-ray, each deviation of the six degrees-of-freedom (6 DOF) of the knee joint is measured for the assessment, by means of an X-ray photograph of the knee joint, before and after stressing the knee joint. By this method, a static deviation can be measured, however, a dynamic 6 DOF of the knee joint cannot be measured.

The dynamic measurement can be done by using fluoroscopy, however, a major measured object of the measurement is limited to the knee joint between the thigh and the cruris each having an implant inserted thereinto. Further, the measurement has a problem that the equipment for the measurement is large and a patient may be affected by X-rays. Therefore, the measurement cannot be easily carried out on an outpatient.

Therefore, in a general manual test, a clinical examiner usually evaluates the test only subjectively. Thus, it is a problem that the evaluation may vary between different examiners or even for one examiner. Further, it is difficult to quantitatively evaluate the motion of the knee joint during a dynamic manual test.

In the assessment of the injury of the ligament of the knee joint, for example, it is very important to allow the different examiners or the same examiner to objectively or quantitatively evaluate the injury. However, as described above, it is difficult to noninvasively and quantitatively evaluate the motion of the knee joint during a dynamic manual test.

As one solution for the above problem, in the gait analysis field, an equipment for measuring 6 DOF of the knee joint has been proposed, in which optical markers are attached to the thigh and the cruris and coordinate axes of the thigh and the cruris are determined based on several predetermined reference points.

However, as the equipment uses optical markers, the measurement cannot be carried out when the markers are positioned in an invisible area due to the positions and the motions of hands and legs of the examiner during the manual test. When such an optical method is used, as a plurality of cameras must be located away from each other and from the markers, the space required for the measurement is large. Moreover, in a measurement during surgical navigation, pins for fixing the marker must be directly driven into the femur and the tibia. Therefore, it is not practical to apply the measurement using the optical markers to the clinical assessment of an outpatient.

### SUMMARY OF THE INVENTION

Accordingly, an object of the present invention is to provide a noninvasive dynamic analysis system capable of feeding back a measured and analyzed result of a manual test to an examiner in real-time and of evaluating the result dynamically and quantitatively.

In order to accomplish the above object, the invention provides a noninvasive dynamic analysis system for measuring and analyzing the motion of the joint of the human body, the analysis system comprising: an electromagnetic sensor for noninvasively measuring the positions and the orientations of two sites of the human body opposite each other in relation to the joint and during the motion of the joint; an electromagnetic measuring device for determining the positions and the orientations of the two sites based on information from the electromagnetic sensor; a processing device for calculating the degrees-of-freedom of the joint, based on the positions and the orientations of the two sites determined by the electromagnetic measuring device and the position of an anatomic reference point around the joint.

In one embodiment, the electromagnetic sensor includes a transmitter for transmitting an electromagnetic wave and two receivers noninvasively fixed to the two sites on the human body and capable of receiving the electromagnetic wave transmitted by the transmitter.

The noninvasive dynamic analysis system may further comprise a display unit for indicating the result calculated by the processing device in real-time.

The joint measured by the noninvasive dynamic analysis system is preferably the knee joint. In this case, the two sites are the thigh and the cruris and the processing device calculates the six degrees-of-freedom of the knee joint.

The noninvasive dynamic analysis system may further comprise a stylus having a sensor. In this case, the position of the anatomic reference point may be inputted to the processing device by contacting the stylus to the anatomic reference point.

According to another aspect of the invention, there is provided a method for noninvasively measuring and analyzing the motion of the joint of the human body, the method comprising steps of: providing an electromagnetic sensor for noninvasively measuring the positions and the orientations of two sites of the human body opposite each other in relation to the joint, during the motion of the joint; determining the positions and the orientations of the two sites based on information from the electromagnetic sensor; determining the position of an anatomic reference point around the joint; and calculating the degrees-of-freedom of the joint, based on the positions and the orientations of the two sites and the positions of the anatomic reference point.

In one embodiment, the electromagnetic sensor includes a transmitter for transmitting electromagnetic wave and two receivers capable of receiving the electromagnetic wave transmitted by the transmitter. The step of providing the electromagnetic sensor may comprise noninvasively fixing the two receivers to the two sites of the human body.

The step of determining the position of the anatomic reference point may comprise calculating the position of the reference point by analyzing the positions and the orientations of the two receivers attached to the joint, obtained by a predetermined motion of the joint.

The step of calculating the degrees-of-freedom may comprise measuring at least one of a translation, a translation velocity and a translation acceleration of at least one degree-of-freedom of the joint.

According to the present invention, the information of the positions and the orientations of the thigh and the cruris is obtained by the electromagnetic sensor. Therefore, the measurement can be carried out in the space required for a manual test. Further, the measurement is possible even when the sensor is covered by the hand of the examiner or the examiner is positioned between the sensors. In other words, there is no factor which may be an obstacle for the manual test, whereby the measurement in a normal manual test may be possible.

Further, in the present invention, as a brace is used for fixing the sensor, the sensor may be noninvasively and quickly fixed. Also, the sensor may be easily fixed by an inexperienced person, as it is not necessary to drive a pin into the human body, as in case of the optical sensor. The quick and noninvasive measurement contributes to the reduction of pain or discomfort of the patient, thereby the measurement may be employed for a clinical outpatient.

### BRIEF DESCRIPTION OF THE DRAWINGS

The above and other objects, features and advantages of the present invention will be made more apparent by the following description of the preferred embodiments thereof, with reference to the accompanying drawings, wherein:

FIG. 1 is a block diagram showing a general configuration of a noninvasive dynamic analysis system according to the invention;

FIG. 2 is a general configuration according to a preferred embodiment of the noninvasive dynamic analysis system of FIG. 1;

FIG. 3 is a diagram showing an electromagnetic sensor attached to the thigh and the cruris of a patient by braces;

FIG. 4 is a diagram showing inputting a reference point by using a stylus;

FIG. 5 is a diagram showing the positions of reference points around the knee joint;

FIG. 6 is a diagram showing the construction of a coordinate system around the knee;

FIG. 7 is a diagram showing one example for calculating 6 DOF of the knee joint;

FIG. 8 is a graph showing time variation of a translation of the cruris relative to the thigh during the Pivot Shift test, measured by the noninvasive dynamic analysis system of the invention; and

FIG. 9 is a graph showing time variations of a velocity and an acceleration of the translation of the cruris relative to the thigh during the Pivot Shift test, measured by the noninvasive dynamic analysis system of the invention.

### DETAILED DESCRIPTION

Hereafter, one embodiment of the present invention will be described by referring attached drawings.

The term “a noninvasive dynamic analysis system” herein is used as a generic term of a medical analysis system for calculating and analyzing parameters as a quantitative evaluation of the joint during a manual test, in which sensors are positioned at two sites, of the human body opposite to each other in relation to the joint, such as the thigh and the cruris.

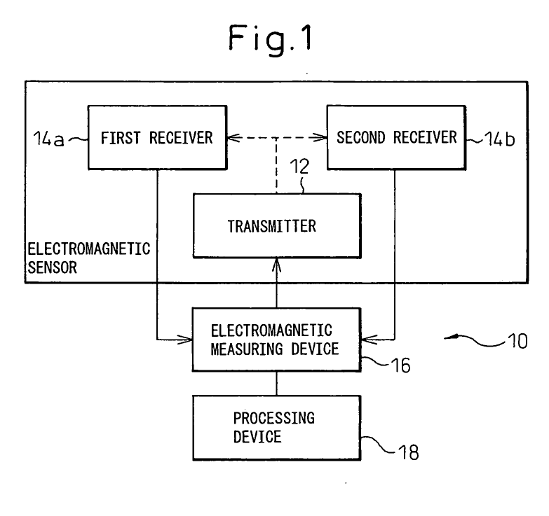

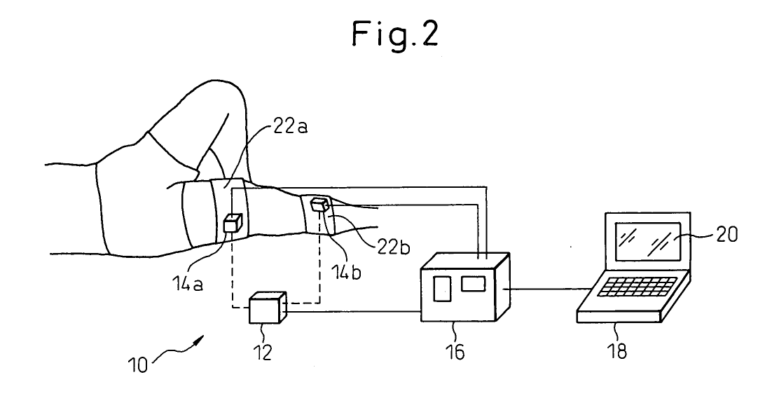

FIG. 1 is a block diagram showing a general configuration of a noninvasive dynamic analysis system 10 according to the invention, adapted for the knee joint of the human body. FIG. 2 is a general configuration of a preferred embodiment of the noninvasive dynamic analysis system. The noninvasive dynamic analysis system 10 includes a transmitter 12 for transmitting electromagnetic wave or an electromagnetic signal; a first receiver 14a and a second receiver 14b fixed to the thigh and the cruris of the human body and capable of receiving the electromagnetic wave transmitted by the transmitter 12; an electromagnetic measuring device 16 for determining the positions and the orientations of the receivers 14a and 14b based on electric signals from the receivers; and a processing device 18, such as a personal computer, for calculating six degrees-of-freedom of the knee joint based on information from the electromagnetic measuring device 16 regarding the positions and the orientations of the receivers. Further, the personal computer 18 includes a display or a display unit 20 for indicating a calculated result in real-time. In this embodiment, the transmitter 12 and the two receivers 14a and 14b cooperate to constitute the electromagnetic sensor. The processing device 18 may indicate the motion of the knee joint, as well as an analyzed result of the knee joint described below. Therefore, a problem with, or the incorrect positioning of, the electromagnetic sensor may be immediately found.

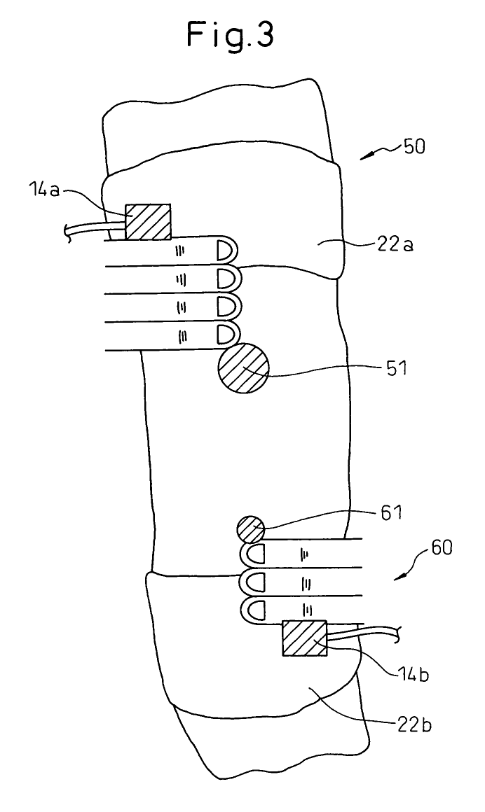

FIG. 3 is a front view of the right leg of the patient and shows preferred positions of the patient where the two receivers 14a and 14b are attached. The receivers 14a and 14b may be fixed to the thigh 50 and the cruris 60 of the human body, respectively, by using braces 22a and 22b. Although each of the receivers may be attached to any position of the thigh 50 or the cruris 60, it is preferable that each receiver is attached to a site where the position and the orientation of each receiver are not substantially or little changed relative to the femur or the tibia, so as to improve a calculation accuracy of 6 DOF of the knee joint described below. Concretely, as shown in FIG. 3, the first receiver 14a is attached to an outside portion of the thigh 50, which is upwardly away from an upper part 51 of the patella by four times of the width of the finger. The second receiver 14b is attached to an inside portion of the cruris 60, which is downwardly away from an lower part 61 of the tibial tuberosity by three times of the width of the finger. In other words, each receiver is preferably attached to a site of the thigh 50 or the cruris 60 having relatively less muscle.

As described above, transmission and reception between the receivers 14a and 14b and the transmitter 12 are carried out by the electromagnetic wave. Therefore, and different to the case of the optical sensor, the measured result of the position and the orientation of each receiver is not adversely effected even when the hand of the examiner or other obstacles is positioned between each receiver and the transmitter. Thus, the examiner may carry out a normal manual test without caring about the positions of the receivers and the transmitter. Further, as shown in FIG. 3, the receivers 14a and 14b are noninvasively fixed to the thigh and the cruris by the braces 22a and 22b, without being fixed directly to the femur and the tibia by pins or the like. This is a significant advantage.

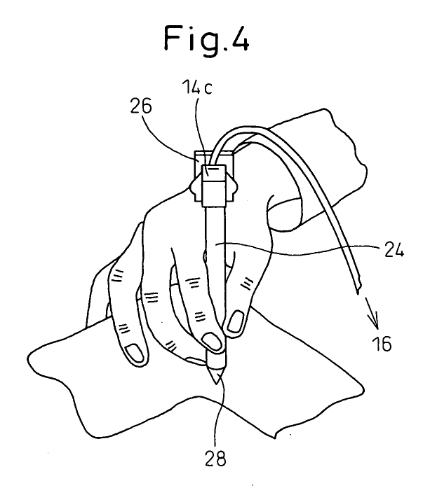

In the present invention, in order to calculate 6 DOF of the knee joint using the above electromagnetic sensor, it is necessary to input coordinates of some anatomic reference points, as well as the measured result by the electromagnetic sensor. Various ways are possible to input the reference points. For example, as shown in FIG. 4, a stylus 24 of a bar shape, having a rear end 26 and a front end 28, may be provided. A receiver 14c, which is preferably similar to the above receiver 14a or 14b, is mounted to the rear end 26 of the stylus 24. When the front end 28 of the stylus 24 contacts the reference points, the coordinates of the reference points may be inputted. As the positional relation of the distance between the front end 28 and the rear end 26 of the stylus may be previously known, any coordinate directed by the examiner may be inputted as one of the reference points.

Alternatively, in order to reduce the workload of inputting the reference points, the leg of the patient may be passively moved such that the leg moves in a predetermined motion, so as to construct a coordinate system by analyzing the information of the positions and orientations of the receivers 14a and 14b obtained by the predetermined motion. Also, the above anatomic reference points may be substituted by the tibial tuberosity, an inner edge and an outer edge of the patella, etc.

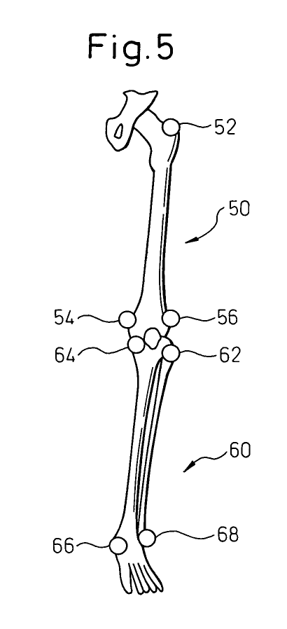

In this embodiment for measuring the knee joint, seven points are inputted as the above anatomic reference points. In detail, as shown in FIG. 5, three points or the greater trochanter 52, the medial epicondyle 54 and the lateral epicondyle 56 are inputted as the reference points of the thigh 50. Further, four points or the caput of fibula 62, the intersection point 64 of the medial collateral ligament (MCL) and a joint line, the medial malleolus 66 and the lateral malleolus 68 are inputted as the reference points of the cruris 60. The joint line used herein is a line along a groove extending between the femur condyle and the tibia condyle.

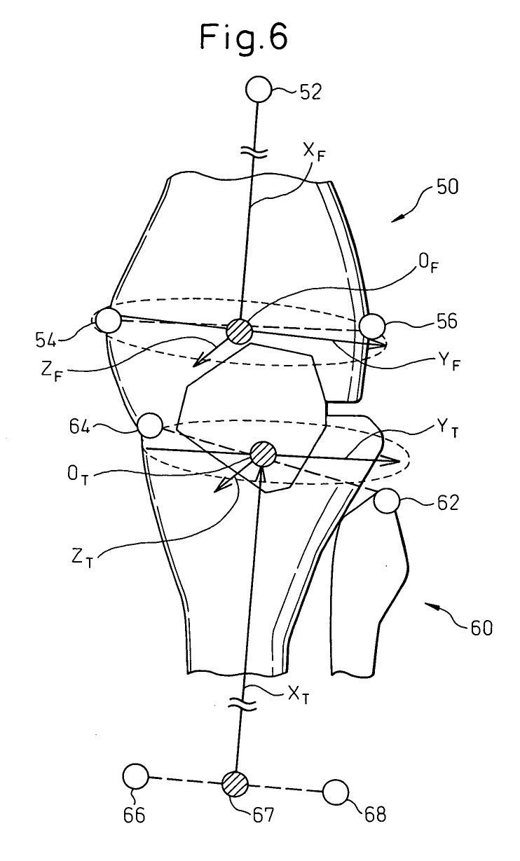

With reference to FIG. 6, construction of a coordinate system of the thigh 50 is first explained. A middle point of the medial epicondyle 54 and the lateral epicondyle 56 is defined as the origin O_{F} of the thigh coordinate system. A straight line extending through the greater trochanter 52 and the origin O_{F} is defined as an axis X_{F}. A straight line extending through two points in a plane, including the origin O_{F} and perpendicular to the axis X_{F}, is defined as an axis Y_{F}, where the two points in the plane are intersection points of the plane and perpendicular lines extending from the medial epicondyle 54 and the lateral epicondyle 56. An axis Z_{F} is a straight line perpendicular to both of the axes X_{F} and Y_{F}. The thigh coordinate system is constructed by these three axes X_{F}, Y_{F} and Z_{F}.

Next, construction of a coordinate system of the cruris 60 is explained. A middle point of the caput of fibula 62 and the intersection point 64 of the MCL and the joint line is defined as the origin O_{T} of the cruris coordinate system. A straight line extending through a middle point 67 of the medial malleolus 66 and the lateral malleolus 68 and the origin O_{T} is defined as an axis X_{T}. A straight line extending through two points in a plane, including the origin O_{T} and perpendicular to the axis X_{T}, is defined as an axis Y_{T}, where the two points in the plane are intersection points of the plane and perpendicular lines extending from the intersection point 64 and the caput of fibula 62. An axis Z_{T} is a straight line perpendicular to both of the axes X_{T} and Y_{T}. The cruris coordinate system is constructed by these three axes X_{T}, Y_{T} and Z_{T}.

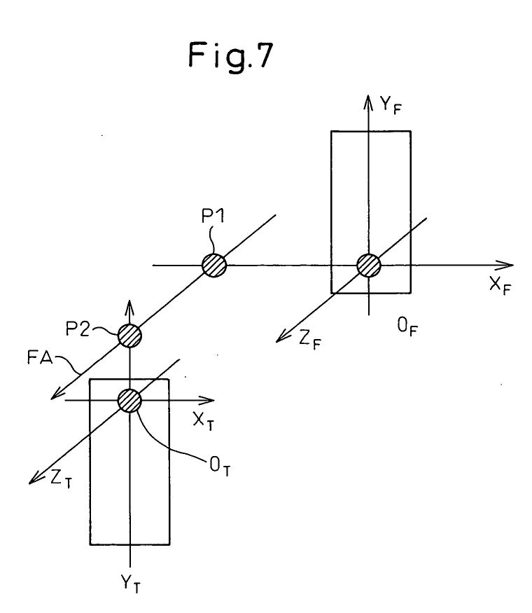

Based on the coordinate system defined as described above and data obtained by the receivers 14a and 14b, further, by utilizing on a method proposed by Grood et al. (see Transaction of ASME. Journal of Biomechanical Engineering, Vol. 105 (May 1983), P136-P144), 6 DOF of the knee joint (i.e., a flexion degree, an abduction degree, a rotation degree, a translation of anterior direction, a translation of thrust direction and a translation of distraction direction) may be calculated. More specifically, as shown in FIG. 7, by defining a floating-axis FA perpendicular to both of the axes X_{F} and Y_{T}, the flexion degree of 6 DOF may be calculated based on the relation between the floating-axis FA and the axis Z_{F}; the abduction degree may be calculated based on the relation between the axes X_{F} and Y_{T}; the rotation degree may be calculated based on the relation between the floating-axis FA and the axis Z_{T}; the translation of anterior direction may be calculated based on the relation between an intersection point P1, of the floating-axis FA and the axis X_{F}, and an intersection point P2, of the floating-axis FA and the axis Y_{T}; the translation of thrust direction may be calculated based on the relation between the intersection point P1, and the origin O_{F}; and the translation of distraction direction may be calculated based on the relation between the intersection point P2 and the origin O_{T}.

One of conventional methods for clinically determining 6 DOF described above is a manual measuring method, in which an X-ray photograph is at first taken and, then, a protractor or a ruler is applied to the photograph. Alternatively, the protractor or the ruler is directory applied to the thigh and the cruris. Disadvantages of the method are that a measurement error may be large as the measurement is manually carried out and that the measurement cannot be dynamically carried out as the measurement in the method is possible only at one time or at one position. Contrarily, it is advantageous to use the analysis system of the invention, by which the dynamic measurement is possible and the result of the measurement may be indicated in real-time. For example, although the Anterior Drawer test should be performed when the flexion degree is equal to 30, 60 or 90 degrees, the flexion degree is roughly and subjectively determined by the examiner. The flexion degree, which is therefore conventionally inaccurate in the test, may be accurately adjusted by the analysis system of the invention.

The display of the personal computer of the analysis system may indicate three-dimensional images of the thigh and the cruris of the patient, as well as 6 DOF of the knee joint in real-time. By carrying out the manual test while observing virtual images of the thigh and the cruris, it may be easy to find a malfunction of the analysis system and/or a mistake regarding installation or wiring of the system.

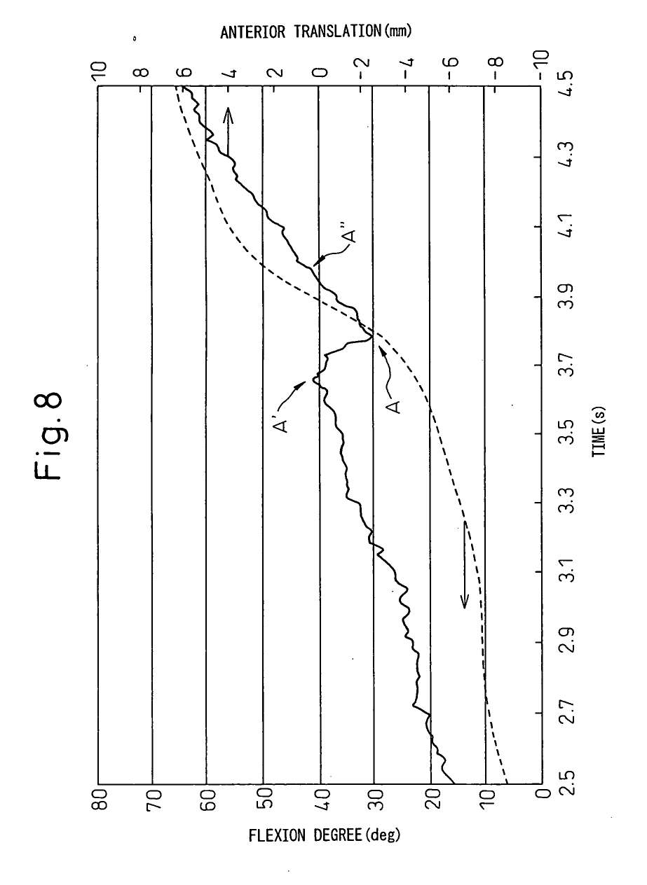

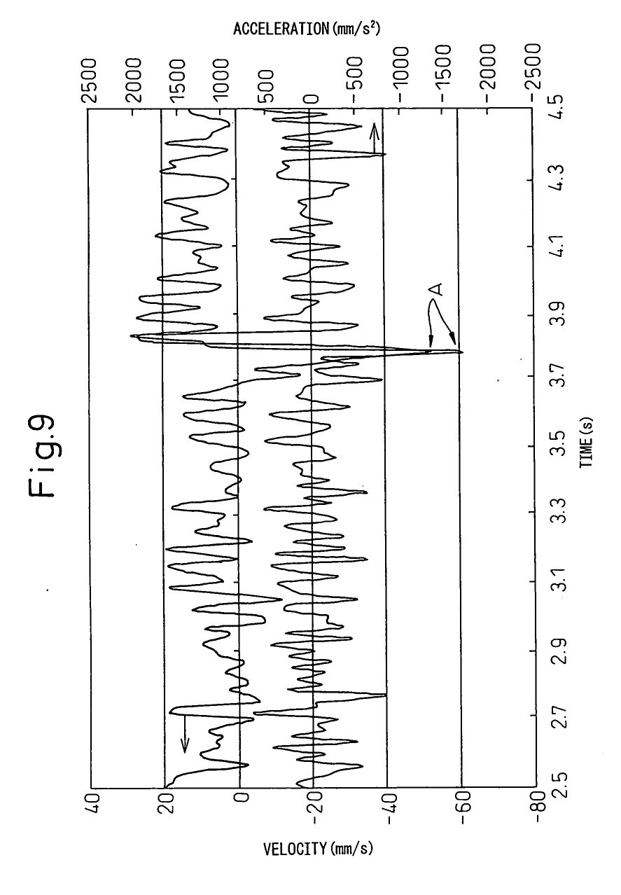

Next, a further advantage of the invention is described. According to the noninvasive dynamic analysis system, 6 DOF of the knee joint may be dynamically measured in real-time. Therefore, a translation (deviation), a velocity and an acceleration of the translation of each of 6 DOF may be quantitatively calculated. For example, FIG. 8 is a graph indicating a change of the translation of the anterior direction of 6 DOF relative to time, in the Pivot Shift test for evaluating the stability of rotation, which was measured by using the noninvasive dynamic analysis system. A dashed line of the FIG. 8 is a graph indicating the flexion degree of the knee joint. At this point, transfer of data from each receiver to the processing device was accelerated by using binary data. A sampling period of the data from each receiver was 60 Hz. Further, FIG. 9 is a graph indicating changes of the velocity and the acceleration of the anterior translation relative to time, which were measured at the same time as the change of FIG. 8.

A point A of FIG. 8 indicates that the change of the anterior translation had a local minimum value when the examiner performed the Pivot Shift test (i.e., the examiner displaced the cruris relative to the thigh while applying a force to the knee joint). In the Pivot Shift test, the motion of the joint near the local minimum point A (more particular, between a point A′, indicating a local maximum point before the point A, and a point A″, indicating a point after the point A where the value of the anterior translation reached to that of the point A′) is very important. Conventionally, the motion or the condition of the joint can be determined only by a palpation of the examiner, therefore, the accuracy of the examination may have a large error, depending on the skill of the examiner. However, according to the invention, the motion of the joint may be quantitatively measured in real-time and the accuracy of the examination may be greatly improved, in relation to the knee joint having, for example, an insufficiency of the anterior cruciate ligament (ACL). In addition, a point A of FIG. 9 corresponds to the point A of FIG. 8. Any of the above translation, velocity and acceleration is available for the analysis of the motion of the joint at the point A. However, it has been found, in many tests, that the acceleration is the best for examining the condition of the joint. This is because the acceleration is less affected by a motion speed of the joint or a way of applying a force to the joint by the examiner.

As described above, by the noninvasive dynamic analysis system of the invention, 6 DOF of the knee joint of the patient may be noninvasively and dynamically measured. Therefore, the analysis system may be clinically used for an outpatient, thereby the examination in a clinical manual test may be evaluated more objectively. As the measured data may be stored and recalled at any time, the change between before and after an operation or the recovery after the operation may be checked. Further, by using the electromagnetic sensor, many advantages may be obtained as follows:

(i) The noninvasive measurement is possible, and not as the conventional measurement using X-rays;

(ii) The requirement in analyzing images using a plurality of cameras (i.e., a certain space for the measurement must be kept and shielding or the like must not be positioned between each camera and a marker) does not need to be considered; and

(iii) The manual test using the system of the invention may be carried out easier than the test using a mechanical measurement device in which the patient is restrained by a large mechanical orthosis.

Therefore, the analysis system of the invention may be applied to the clinical manual test. In addition, although the analysis system of the invention is preferably applied to the assessment of a hinge type joint such as the knee joint and the elbow joint, the system may be obviously applied to another type of joint.

While the invention has been described with reference to specific embodiments chosen for the purpose of illustration, it should be apparent that numerous modifications could be made thereto, by one skilled in the art, without departing from the basic concept and scope of the invention.

1. A noninvasive dynamic analysis system for measuring and analyzing the motion of the joint of the human body, the analysis system comprising:
an electromagnetic sensor for noninvasively measuring the positions and the orientations of two sites of the human body opposite each other in relation to the joint and during the motion of the joint;
an electromagnetic measuring device for determining the positions and the orientations of the two sites based on information from the electromagnetic sensor;
a processing device for calculating the degrees-of-freedom of the joint, based on the positions and the orientations of the two sites determined by the electromagnetic measuring device and the position of an anatomic reference point around the joint.

2. The noninvasive dynamic analysis system as set forth in claim 1, wherein the electromagnetic sensor comprises a transmitter for transmitting an electromagnetic wave and two receivers noninvasively fixed to two sites on the human body and capable of receiving the electromagnetic wave transmitted by the transmitter.

3. The noninvasive dynamic analysis system as set forth in claim 1, further comprising a display unit for indicating the result calculated by the processing device in real-time.

4. The noninvasive dynamic analysis system as set forth in claim 1, wherein the joint is the knee joint, the two sites are the thigh and the cruris and the processing device calculates the six degrees-of-freedom of the knee joint.

5. The noninvasive dynamic analysis system as set forth in claim 1, further comprising a stylus having a sensor, and the position of the anatomic reference point can be inputted to the processing device by contacting the stylus to the anatomic reference point.

6. A method for noninvasively measuring and analyzing the motion of the joint of the human body, the method comprising steps of:
providing an electromagnetic sensor for noninvasively measuring the positions and the orientations of two sites on the human body opposite each other in relation to the joint and during the motion of the joint;
determining the positions and the orientations of the two sites based on information from the electromagnetic sensor;
determining the position of an anatomic reference point around the joint;
calculating the degrees-of-freedom of the joint, based on the positions and the orientations of the two sites and the positions of the anatomic reference point.

7. The method as set forth in claim 6, wherein the electromagnetic sensor comprises a transmitter for transmitting an electromagnetic wave and two receivers capable of receiving the electromagnetic wave transmitted by the transmitter, the step of providing the electromagnetic sensor comprises noninvasively fixing the two receivers to the two sites of the human body.

8. The method as set forth in claim 7, wherein the step of determining the position of the anatomic reference point comprises calculating the position of the reference point by analyzing the positions and the orientations, of the two receivers attached to the joint, obtained by a predetermined motion of the joint.

9. The method as set forth in claim 6, wherein the step of calculating the degrees-of-freedom comprises measuring a translation of at least one degree-of-freedom of the joint.

10. The method as set forth in claim 6, wherein the step of calculating the degrees-of-freedom comprises measuring a velocity of translation of at least one degree-of-freedom of the joint.

11. The method as set forth in claim 6, wherein the step of calculating the degrees-of-freedom comprises measuring an acceleration of a translation at least one degree-of-freedom of the joint.
